(19) United States
(12) Patent Application Publication
(10) Pub. No.: US 2017/0092005 A1
(43) Pub. Date: Mar. 30, 2017

(54) THREE-DIMENSIONAL SHAPING SYSTEM, AND INFORMATION PROCESSING DEVICE AND METHOD

(71) Applicant: FUJIFILM Corporation, Tokyo (JP)

(72) Inventor: Yu HASEGAWA, Tokyo (JP)

(73) Assignee: FUJIFILM Corporation, Tokyo (JP)

(21) Appl. No.: 15/267,447

(22) Filed: Sep. 16, 2016

(30) Foreign Application Priority Data
Sep. 29, 2015 (JP) 2015-191078

(51) Int. Cl. G06T 19/00; G06T 7/00

(52) U.S. Cl. CPC G06T 19/006; G06T 7/0046; G06T 2207/30208; G06T 2215/16; G06T 2219/2004; G06T 2210/41; G06T 2207/10012

(57) ABSTRACT

A three-dimensional shaping system (10) includes a device (20) which acquires three-dimensional data, a device (22) which generates shaping target object data from the three-dimensional data, a device (26) which generates three-dimensional shaping data by adding, to the shaping target object data, attachment part data representing a three-dimensional shape of a marker attachment part (42) for attaching a marker (50) to a shaped object (40) shaped based on the shaping target object data, a device (14) which shapes and outputs the shaped object on the basis of the three-dimensional shaping data, an imaging device (60) which images the shaped object (40) in a state of the marker (50) being attached, and a device (76) which recognizes the marker from a captured image to calculate a camera parameter.

### CROSS-REFERENCE TO RELATED APPLICATIONS

The present application claims priority under 35 U.S.C. §119 to Japanese Patent Application No. 2015-191078, filed on Sep. 29, 2015. The above application is hereby expressly incorporated by reference, in its entirety, into the present application.

### BACKGROUND OF THE INVENTION

Field of the Invention

The present invention relates to a three-dimensional shaping system, information processing device and method, and a program, and in particular, relates to a three- dimensional shaping technology and an information processing technology of shaping and outputting a shaped object of a solid model on the basis of three-dimensional data obtained from a medical image diagnosis device or the like.

Description of the Related Art

In the field of medicine, it is recently expected that a human body model such as organs, blood vessels and bones is shaped using a 3D printer to help discussion on a surgical procedure and unity of purpose between the members in a preoperative conference. The term 3D is an abbreviation of “Three-Dimensional” or “Three Dimensions” and means “three-dimensional”. Japanese Patent Application Laid-Open No. 2011-224194 (hereinafter referred to as Patent Literature 1) discloses a technology in which a three-dimensional solid model is shaped by a 3D printer based on three-dimensional image data obtained by a medical image diagnosis device such as a CT (Computerized Tomography) device and an MRI (Magnetic Resonance Imaging) device.

Moreover, Japanese Patent Application Laid-Open No. 2008-40913 (hereinafter referred to as Patent Literature 2) discloses that on a simple prototype object created by a rapid prototyping device based on a three-dimensional CAD (Computer Aided Design) data, 3D-CG (Computer Graphic) data created from the same three-dimensional CAD data is superimposed and displayed. The rapid prototyping device is a term corresponding to a “3D printer”.

Patent literature 2 discloses a method of determining a position and a posture of an object by extracting geometric features of the object on the basis of two-dimensional image information obtained from an imaging device, and a method of imaging a marker as an index, regarding a method of positioning between a real space and a virtual space.

### SUMMARY OF THE INVENTION

Conventionally, there is known a method of displaying an organ model and a tumor model acquired from a three-dimensional image such as CT data to perform simulation in a preoperative conference by using augmented reality (AR; Augmented Reality). However, there is a problem that feeling of actual size is hardly achieved in the augmented reality because of incapability of touching an actual model. On the other hand, while the problem is solved by performing a preoperative conference using a shaped object created by a 3D printer, there is a problem that the shaping output costs high in time and in price. As a method of solving these problems, there can be considered a method of superimposing and displaying a virtual object body on a shaped object obtained by 3D printing in augmented reality. The virtual object body is synonymous to “virtual object” or “virtual model”.

As one of technical problems in providing a method of making reduction of material costs compatible with easiness of grasping actual size by combining production of an actual shaped object by a 3D printer with augmented reality, it is needed that from an image obtained by imaging the actual shaped object, a position, a posture and the like of the shaped object be grasped.

As to this point, as a method of positioning between the shaped object and the virtual model, there are a method of using pattern matching, and a method in which three or more markers as indices of specific positions are pasted on the shaped object and where each marker position corresponds to on the virtual model is given as an input. Nevertheless, the former method leads to a problem of high calculation costs, and the latter method leads to a problem of user's labor of inputting the marker positions.

Such problems are common problems to shaped objects of various three-dimensional models including industrial products as well as shaped objects of human body models used in the field of medicine.

The present invention is devised in view of such circumstances and an object thereof is to provide a three-dimensional shaping system, information processing device and method, and a program which enable simple acquisition of information regarding a position and a posture of a shaped object from a captured image obtained by imaging the shaped object three-dimensionally shaped and outputted based on three-dimensional data.

The following aspects of the invention are provided to solve the problems.

There is provided a three-dimensional shaping system according to a first aspect of the present invention, including: a three-dimensional data acquiring device which acquires three-dimensional data representing a three-dimensional structure object; a shaping target object data generating device which generates shaping target object data representing a structure object as a shaping target from the three-dimensional data; a three-dimensional shaping data generating device which generates three-dimensional shaping data by adding, to the shaping target object data, attachment part data representing a three-dimensional shape of a marker attachment part for attaching a positioning marker to a shaped object shaped based on the shaping target object data; a three-dimensional shaping and outputting device which shapes and outputs the shaped object having the marker attachment part on the basis of the three-dimensional shaping data; an imaging device which images the shaped object in a state where the marker is attached to the marker attachment part of the shaped object; and a camera parameter calculating device which calculates a camera parameter including information representing relative positional relation between the imaging device and the shaped object by recognizing the marker from a captured image imaged by the imaging device.

According to the first aspect, when the shaped object is shaped based on the shaping target object data generated from the three-dimensional data, the three-dimensional shaping data is generated by adding, to the shaping target object data, the attachment part data representing the three-dimensional shape of the marker attachment part. The shaped object is shaped and outputted based on this three-dimensional shaping data by the three-dimensional shaping and outputting device, and thereby, the shaped object having the marker attachment part is obtained. By attaching the beforehand prepared marker to the marker attachment part of the shaped object, the marker can be fixed to the shaped object at a specific position. The shaped object in the state of the marker being attached is imaged and the marker is recognized from the obtained captured image, and thereby, the camera parameter including the information representing the relative positional relation between the imaging device and the shaped object is calculated. By using the camera parameter calculated in this way, a virtual object and various kinds of information can be displayed on the shaped object.

According to the first aspect, a process of inputting a corresponding position by a user and the similar process are not needed, and the camera parameter can be simply obtained. Moreover, according to the first aspect, as compared with the method of using pattern matching, calculation costs are low and positioning needed for displaying the virtual object or the like can be simply performed.

As a second aspect of the present invention, in the three-dimensional shaping system according to the first aspect, there can be provided a configuration in which the camera parameter includes a position of the imaging device, an imaging direction of the imaging device, and a distance between the imaging device and the shaped object.

As a third aspect of the present invention, in the three-dimensional shaping system of the first aspect or the second aspect, there can be provided a configuration in which the marker has a connection part connected to the marker attachment part, and the marker is fixed to the shaped object by fitting coupling between the connection part and the marker attachment part.

As a fourth aspect of the present invention, in the three-dimensional shaping system of the third aspect, there can be provided a configuration in which one of the marker attachment part and the connection part is of male screw type and the other is of female screw type.

As a fifth aspect of the present invention, in the three-dimensional shaping system of the third aspect or the fourth aspect, there can be provided a configuration in which the marker has a hole which is the connection part on one face of six faces of a hexahedron, and each of the other five faces is given a different pattern.

As a sixth aspect of the present invention, in the three-dimensional shaping system of any one aspect of the first aspect to the fifth aspect, there can be provided a configuration of further including a positioning processing device which specifies a correspondence relation between the three-dimensional data and a position of the real shaped object based on the camera parameter.

As a seventh aspect of the present invention, in the three-dimensional shaping system of any one aspect of the first aspect and the sixth aspect, there can be provided a configuration of further including: a display data generating device which generates display data depending on a posture of the shaped object using the camera parameter; and a display performing device which displays information depending on the posture of the shaped object on the basis of the display data.

The three-dimensional shaping system of the seventh aspect can be understood as a displaying system which provides augmented reality or an augmented reality providing system.

As an eighth aspect of the present invention, in the three-dimensional shaping system of the seventh aspect, there can be provided a configuration of further including a region of interest extracting device which extracts a region of interest at least including a three-dimensional region as a non-shaping target from the three-dimensional data, wherein the display data generating device generates the display data for displaying a virtual object of the region of interest using the camera parameter based on three-dimensional data corresponding to the region of interest extracted by the region of interest extracting device.

As a ninth aspect of the present invention, in the three-dimensional shaping system of the eighth aspect, there can be provided a configuration in which the display data generating device generates the display data for superimposing and displaying the virtual object on the captured image.

As a tenth aspect of the present invention, in the three-dimensional shaping system of any one aspect of the seventh aspect to the ninth aspect, there can be provided a configuration of further including an image working device which erases and removes an image portion of the marker from the captured image, wherein the display data generating device generates the display data for displaying an image in which the image portion of the marker is erased from the captured image.

As an eleventh aspect of the present invention, in the three-dimensional shaping system of any one aspect of the first aspect to the tenth aspect, there can be provided a configuration in which the three-dimensional data is medical image data acquired by a medical image diagnosis device.

There is provided an information processing method according to a twelfth aspect of the present invention, including: a three-dimensional data acquiring step of acquiring three-dimensional data representing a three-dimensional structure object; a shaping target object data generating step of generating shaping target object data representing a structure object as a shaping target from the three-dimensional data; a three-dimensional shaping data generating step of generating three-dimensional shaping data by adding, to the shaping target object data, attachment part data representing a three-dimensional shape of a marker attachment part for attaching a positioning marker to a shaped object shaped based on the shaping target object data; a three-dimensional shaping and outputting step of shaping and outputting the shaped object having the marker attachment part on the basis of the three-dimensional shaping data; an imaging step of imaging the shaped object by an imaging device in a state where the marker is attached to the marker attachment part of the shaped object; and a camera parameter calculating step of calculating a camera parameter including information representing relative positional relation between the imaging device and the shaped object by recognizing the marker from a captured image imaged by the imaging step.

The information processing method of the twelfth aspect can be used for providing augmented reality. The information processing method of the twelfth aspect can be understood as an augmented reality providing method.

In the twelfth aspect, matters similar to the matters specified in the second aspect to the eleventh aspect can be properly combined. In such a case, a device that serves the processing or the function specified in the three-dimensional shaping system can be understood as an element of a corresponding “process (step)” of the processing or the operation.

There is provided an information processing device according to a thirteenth aspect of the present invention, including: a three-dimensional data acquiring device which acquires three-dimensional data representing a three-dimensional structure object; a shaping target object data generating device which generates shaping target object data representing a structure object as a shaping target from the three-dimensional data; an attachment data storing device which stores attachment part data representing a three-dimensional shape of a marker attachment part for attaching a positioning marker to a shaped object shaped based on the shaping target object data; a three-dimensional shaping data generating device which generates three-dimensional shaping data by adding the attachment part data to the shaping target object data; and a data outputting device which outputs the three-dimensional shaping data.

According to the thirteenth aspect, the three-dimensional shaping data is generated by adding, to the shaping target object data generated from the three-dimensional data, the attachment part data representing the three-dimensional shape of the marker attachment part. The shaped object is shaped and outputted based on this three-dimensional shaping data by the three-dimensional shaping and outputting device, and thereby, the shaped object having the marker attachment part can be manufactured.

In the thirteenth aspect, matters similar to the matters specified in the second aspect to the eleventh aspect can be properly combined.

There is provided a three-dimensional shaping system according to a fourteenth aspect of the present invention, including: the information processing device of the thirteenth aspect; and a three-dimensional shaping and outputting device which shapes and outputs the shaped object having the marker attachment part on the basis of the three-dimensional shaping data.

There is provided a program according to a fifteenth aspect of the present invention, the program for causing a computer to function as: a three-dimensional data acquiring device which acquires three-dimensional data representing a three-dimensional structure object; a shaping target object data generating device which generates shaping target object data representing a structure object as a shaping target from the three-dimensional data; a three-dimensional shaping data generating device which generates three-dimensional shaping data by adding, to the shaping target object data, attachment part data representing a three-dimensional shape of a marker attachment part for attaching a positioning marker to a shaped object shaped based on the shaping target object data; and a data outputting device which outputs the three-dimensional shaping data.

In the program of the fifteenth aspect, matters similar to the matters specified in the second aspect to the eleventh aspect can be properly combined.

According to the present invention, a camera parameter can be simply obtained from a captured image obtained by imaging a shaped object three-dimensionally shaped and outputted based on three-dimensional data, and information regarding a position and a posture of the shaped object, the information being needed for display in augmented reality or the like can be simply acquired.

### BRIEF DESCRIPTION OF THE DRAWINGS

FIG. 1 is a block diagram showing an exemplary configuration of a three-dimensional shaping system according to an embodiment of the present invention;

FIG. 2 is a flowchart showing a manufacturing procedure of a shaped object by the three-dimensional shaping system;

FIG. 3 is a schematic diagram exemplarily showing three-dimensional data;

FIG. 4 is a diagram exemplarily showing data obtained by extracting only a structure object as a shaping target from the three-dimensional data in FIG. 3;

FIG. 5 is an expanded view of the main part showing a situation in which attachment data representing a three-dimensional shape of a marker attachment part is added to shaping target object data;

FIG. 6 is a perspective view exemplarily showing a shaped object shaped and outputted based on 3D printing data to which the attachment data is added;

FIG. 7 is a perspective view showing a situation in which a marker is fixed to the shaped object shown in FIG. 6;

FIG. 8 is a diagram exemplarily showing an image of a job edit screen;

FIG. 9 is a flowchart exemplarily showing a method of providing augmented reality using the shaped object;

FIG. 10 is an explanatory drawing showing a situation in imaging the shaped object;

FIG. 11 is a diagram exemplarily showing a captured image imaged in the imaging situation of FIG. 10;

FIG. 12 is a cross-sectional view of the main part showing another embodiment regarding an attachment structure of a marker with respect to the shaped object;

FIG. 13 is a perspective view showing a situation in which the marker is fixed to the shaped object obtained by shaping a model of blood vessels of the liver; and

FIG. 14 is a diagram showing a display example in which virtual objects of the liver and the lesion region are superimposed and displayed on the shaped object of FIG. 13.

### DETAILED DESCRIPTION OF THE PREFERRED EMBODIMENTS

Hereafter, an embodiment of the present invention is described in detail in accordance with the appended drawings.

[Exemplary Configuration of Three-Dimensional Shaping System]

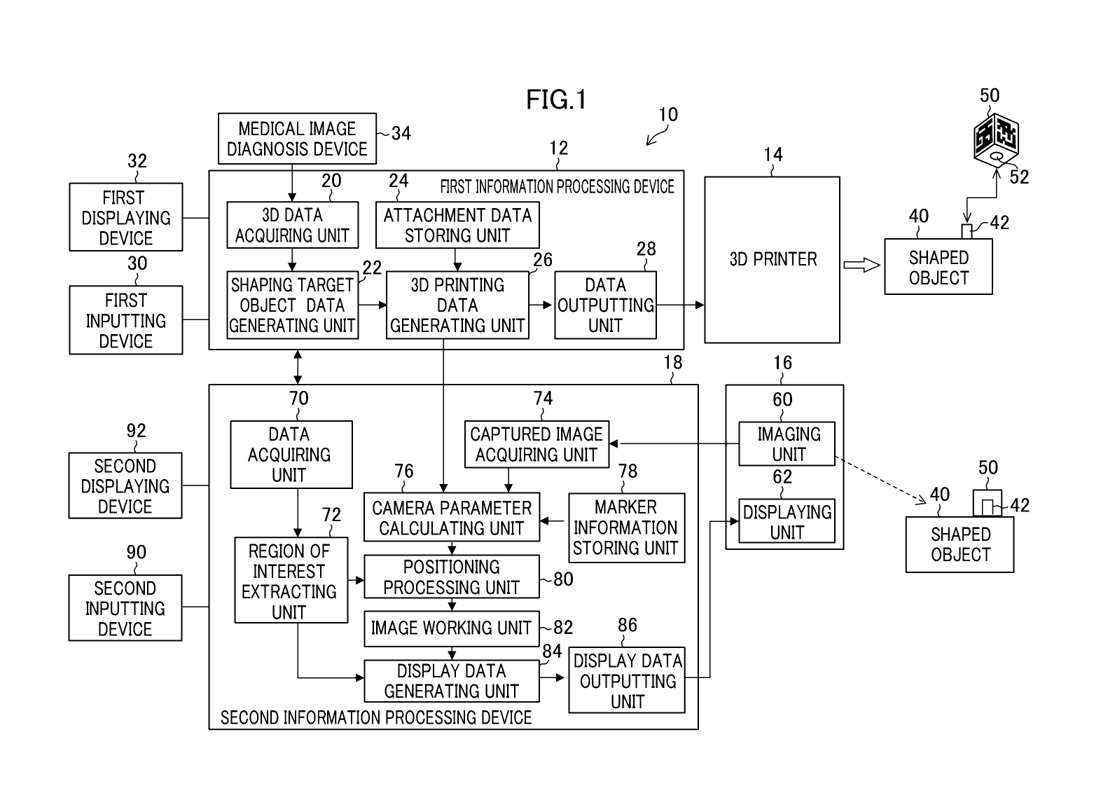

FIG. 1 is a block diagram showing an exemplary configuration of a three-dimensional shaping system 10 according to an embodiment of the present invention. The three-dimensional shaping system 10 includes a first information processing device 12, a 3D printer 14, a head mounted display 16 and a second information processing device 18.

The first information processing device 12 includes a 3D data acquiring unit 20, a shaping target object data generating unit 22, an attachment data storing unit 24, a 3D printing data generating unit 26 and a data outputting unit 28. Moreover, the first information processing device 12 includes a first inputting device 30 and a first displaying device 32.

The first information processing device 12 is constituted of hardware and software of a computer. The software is synonymous to a “program”. The 3D data acquiring unit 20 is a data input interface which acquires three-dimensional data representing a three-dimensional structure object. The three-dimensional data is sometimes noted as “3D data”. The 3D data handled in the embodiment is set as medical image data representing a structure of a part of or the whole human body imaged by a medical image diagnosis device 34. The medical image diagnosis device 34 corresponds to various devices such, for example, as a CT device, an MRI device, an OCT (Optical Coherence Tomography) device, an ultrasonic diagnosis device and an endoscopic device.

The 3D data acquiring unit 20 acquires, for example, CT voxel data including the liver of a patient. The 3D data acquiring unit 20 can be constituted of a data input terminal through which an image is taken in from another signal processing unit outside or inside the device. A wired or wireless communication interface unit may be employed as the 3D data acquiring unit 20, or a medium interface unit which performs reading and writing on a portable external storage medium such as a memory card may also be employed, or these modes may also be properly combined. The 3D data acquiring unit 20 corresponds to a mode of a “three-dimensional data acquiring device”.

The shaping target object data generating unit 22 is a processing unit which generates data of a structure object as a target of shaping output from the 3D data acquired via the 3D data acquiring unit 20. The structure object as the target of shaping output is called a “shaping target object”. Exemplarily presenting, the shaping target object data generating unit 22 performs processing of generating data of blood vessels as the target of shaping output from 3D data of the liver. The data of the shaping target object is called a “shaping target object data”. To “generate” the shaping target object data also includes a concept of “recognizing”, “extracting”, “configuring” or “determining” a relevant data portion from among the 3D data. For example, only blood vessels having at least certain diameter in the liver are extracted as a region of the shaping target object.

As to which portion is set as the target of shaping output from among the 3D data, manual selection may be performed or automatic selection may also be performed. For example, seeing a visual image of the three-dimensional data displayed on the first displaying device 32, the first inputting device 30 can be operated to designate a desired region of the shaping target object. Moreover, for example, programming may be made such that a relevant portion of blood vessels is automatically extracted from among the 3D data, by designating “blood vessels” having at least certain thickness in the 3D data as the structure object of a shaping target. The shaping target object data generating unit 22 corresponds to a mode of a “shaping target object data generating device”.

The attachment data storing unit 24 is a device which stores attachment part data representing a three-dimensional shape of a marker attachment part 42 for attaching a positioning marker 50 to a shaped object 40 shaped by the 3D printer 14 based on the shaping target object data. The attachment data storing unit 24 corresponds to a mode of an “attachment data storing device”.

The marker 50 in this example is a solid marker which can be freely detachably fixed to the shaped object 40, and its surface is given a geometric pattern. The marker 50 has a connection part 52 for performing connection to the marker attachment part 42. Fitting coupling between the connection part 52 of the marker 50 and the marker attachment part 42 of the shaped object 40 fixes the marker 50 to the shaped object 40.

The attachment part data stored in the attachment data storing unit 24 is data representing a three-dimensional shape fitted to the connection part 52 corresponding to a three-dimensional shape of the connection part 52 of the marker 50.

The 3D printing data generating unit 26 generates 3D printing data by adding the attachment part data to the shaping target object data generated by the shaping target object data generating unit 22. The 3D printing data is data for shaping and outputting a three-dimensional structure object obtained by adding the marker attachment part 42 to the solid model of the shaping target object by the 3D printer 14. The 3D printing data corresponds to a mode of a “three-dimensional shaping data”. The 3D printing data generating unit 26 corresponds to a mode of a “three-dimensional shaping data generating device”.

The data outputting unit 28 is a data output interface for outputting the 3D printing data generated by the 3D printing data generating unit 26 to the outside. A wired or wireless communication interface unit may be employed as the data outputting unit 28, or a medium interface unit which performs reading and writing on a portable external storage medium such as a memory card may also be employed, or these modes may also be properly combined. The data outputting unit 28 corresponds to a mode of a “data outputting device”.

The 3D printing data generated by the 3D printing data generating unit 26 is sent to the 3D printer 14 via the data outputting unit 28.

A combination of the first inputting device 30 and the first displaying device functions as a user interface of the first information processing device 12. The first inputting device 30 functions as an operation unit for performing operation of inputting various kinds of information. Various devices such as a keyboard, a mouse, a touch panel and a trackball can be employed for the first inputting device 30, or these may also be properly combined. The first displaying device 32 functions as a displaying unit which displays various kinds of information. For example, display devices in various display systems such as a liquid crystal display and an organic EL (Organic Electro-Luminescence) display can be used for the first displaying device 32. Manipulation such as input and configuration of an instruction to the first information processing device 12 can be performed using the first inputting device 30 and the first displaying device 32.

The 3D printer 14 corresponds to a mode of a “three-dimensional shaping and outputting device”. The 3D printer 14 shapes and outputs the shaped object 40 having the marker attachment part 42 on the basis of the 3D printing data. A shaping system of the 3D printer 14 is not specially limited. Shaping systems of the 3D printer 14 include, for example, a thermal melting deposition system, an ink jet system, a light shaping system, a powder sticking system and the like. The thermal melting deposition system is a system in which heated and melted resin is stacked in stages, and is called an FDM (Fused Deposition Modeling) system. The ink jet system is a system in which ultraviolet-setting resin is ejected from an ink jet-system discharge head, ultraviolet light is applied thereto, and thereby, the resin is caused to set and is stacked. The light shaping system is a system in which ultraviolet light or the like is applied to liquid resin, the resin is caused to set in stages, and thereby, shaping is performed. The powder sticking system is a method in which adhesive is sprayed to powder resin to solidify it. The light shaping system in which ultraviolet light or the like is applied to liquid resin and the resin is caused to set in stages can be employed. Notably, there can be a mode in which a 3D plotter in a cutting shaping method is used as the three-dimensional shaping and outputting device in place of the 3D printer 14.

The connection part 52 of the marker 50 is fitted to the marker attachment part 42 of the shaped object 40 shaped and outputted by the 3D printer 14 to fix the marker 50 to the shaped object 40.

The head mounted display 16 is a goggles-type (or glasses-type) displaying device including an imaging function, and includes an imaging unit 60 and a displaying unit 62. The imaging unit 60 is a camera unit including not-shown imaging lens and image sensor. In this example, the shaped object 40 in the state where the marker 50 is attached thereto is imaged by the imaging unit 60 to obtain a captured image of the shaped object 40. The imaging unit 60 corresponds to a mode of an “imaging device”. The imaging unit 60 performs imaging of at least one still image. Preferably, the imaging unit 60 performs continuous imaging to chronologically acquire captured images.

The displaying unit 62 is a displaying device which displays information generated based on the captured image imaged by the imaging unit 60. The displaying unit 62 may be constituted of a non-transmission displaying device, or may also be constituted of a transmission displaying device. The displaying unit 62 corresponds to a mode of a “display performing device”.

The second information processing device 18 has an image processing function of processing the captured image imaged by the imaging unit 60, and a display controlling function of generating display data displayed on the displaying unit 62. The second information processing device 18 includes a data acquiring unit 70, a region of interest extracting unit 72, a captured image acquiring unit 74, a camera parameter calculating unit 76, a marker information storing unit 78, a positioning processing unit 80, an image working unit 82, a display data generating unit 84 and a display data outputting unit 86. Moreover, the second information processing device 18 includes a second inputting device 90 and a second displaying device 92 which function as a user interface. Configurations of the second inputting device 90 and the second displaying device 92 are similar to the configurations of the first inputting device 30 and the first displaying device 32. The second information processing device 18 can be constituted of hardware and software of a computer.

The data acquiring unit 70 is an interface through which various kinds of data are acquired from the first information processing device 12. The second information processing device 18 can acquire the 3D data, the shaping target object data, the 3D printing data and the like via the data acquiring unit 70.

The region of interest extracting unit 72 performs processing of extracting a designated region of interest from the 3D data. To “extract” also includes a concept of “recognizing”, “configuring” or “determining”. The region of interest is designated as a region at least including a three-dimensional region other than the structure object as the shaping target out of the 3D data. Namely, the region of interest at least includes a three-dimensional region as a non-shaping target. For example, a lesion region, in the liver, which is not shaped by the 3D printer 14 is designated as the region of interest. Notably, the region of interest may be manually designated or may also be automatically designated. Operation of manually designating the region of interest can also be performed using the second inputting device 90 and the second displaying device 92, or can also be performed using the first inputting device 30 and the first displaying device 32. The region of interest extracting unit 72 corresponds to a mode of a “region of interest extracting device”.

The captured image acquiring unit 74 is an image data input interface through which the captured image imaged by the imaging unit 60 of the head mounted display 16 is taken in. The captured image acquiring unit 74 can be constituted of a data input terminal through which an image signal from the imaging unit 60 is taken in. Moreover, a wired or wireless communication interface unit may be employed as the captured image acquiring unit 74.

The camera parameter calculating unit 76 recognizes the marker 50 from the captured image imaged by the imaging unit 60, and performs arithmetic processing of calculating camera parameters including information representing relative positional relation between the imaging unit 60 and the shaped object 40 which is a subject from image information of the marker 50. The camera parameters include the position of the imaging unit 60, the imaging direction of the imaging unit 60, and the distance between the imaging unit 60 and the shaped object 40. Since the marker 50 is fixed to a predetermined specific place of the shaped object 40 in a predetermined direction (posture), the camera parameters can be calculated from the information of the marker 50 in the captured image.

The camera parameter calculating unit 76 recognizes the marker 50 from the captured image using an image recognition technology, and calculates relative positional relation between the imaging unit 60 and the marker 50 (in other words, relative positional relation between the imaging unit 60 and the shaped object 40) on the basis of the appearance of the imaged marker 50. The relative positional relation includes the posture of the marker 50 with respect to the imaging unit 60 (that is, the posture of the shaped object 40). The camera parameter calculating unit 76 corresponds to a mode of a “camera parameter calculating device”.

The marker information storing unit 78 stores marker information indicating geometric features of the marker 50. The marker information includes information for identifying the stereoscopic shape of the marker 50, and the geometric pattern given on the surface of the marker 50. The camera parameter calculating unit 76 calculates the camera parameters using the marker information stored in the marker information storing unit 78 and the image information of the marker 50 in the captured image.

The positioning processing unit 80 performs processing of specifying a correspondence relation between the 3D data and the position of the real shaped object 40 imaged by the imaging unit 60 based on the camera parameters calculated by the camera parameter calculating unit 76. Since the shaped object 40 is shaped based on the 3D printing data generated from the 3D data, the correspondence relation between the position on the data in the 3D printing data and the position on the object in the real shaped object 40 can be specified based on the camera parameters. Since the correspondence relation between the coordinate system in the 3D data and the coordinate system in the 3D printing data is apparent, the correspondence relation between the 3D data and the position of the real shaped object 40 can be grasped. The positioning processing unit 80 can grasp the correspondence relation between the positions of the region of interest extracted by the region of interest extracting unit 72 and the shaped object 40 imaged by the imaging unit 60. The positioning processing unit 80 corresponds to a mode of a “positioning processing device”.

The image working unit 82 is a processing unit of performing working on the captured image imaged by the imaging unit 60. The image working unit 82 performs processing of erasing and removing an image portion of the marker 50 from the captured image. Since the marker 50 is an accessory component which is attached to the shaped object 40 in order to obtain the camera parameters, there is small necessity of displaying the information of the marker 50 when the captured image of the shaped object 40 is displayed on the displaying unit 62. Accordingly, it is preferable that processing of causing an image portion of the marker 50 not to be displayed from among the captured image can be selected when a non-transmission displaying device is employed for the displaying unit 62. The image working unit 82 corresponds to a mode of an “image working device”.

The display data generating unit 84 performs processing of generating display data depending on the posture of the shaped object 40 using the camera parameters. The display data generating unit 84 generates the display data for displaying a virtual object of the region of interest based on the three-dimensional data corresponding to the region of interest extracted by the region of interest extracting unit 72. The display data generating unit 84 calculates the posture of the virtual object of the region of interest to be displayed based on the camera parameters, and generates the display data used for displaying the virtual object.

When the displaying unit 62 is constituted of a non-transmission displaying device, the display data generating unit 84 generates display data for performing display with the virtual object superimposed on the captured image imaged by the imaging unit 60. When the displaying unit 62 is constituted of a transmission displaying device, display data is generated in which the virtual object is superimposed at an appropriate position with respect to the shaped object 40 within the field of view of the eyes of a person who puts on the head mounted display 16. Moreover, the display data generating unit 84 can generate display data for displaying various kinds of information in augmented reality as well as the virtual object of the region of interest. The display data generating unit 84 corresponds to a mode of a “display data generating device”.

The display data outputting unit 86 is a data output interface through which the display data generated by the display data generating unit 84 is outputted. The display data outputting unit 86 can be constituted of a data output terminal. Moreover, a wired or wireless communication interface unit can be employed for the display data outputting unit 86.

The display data generated by the display data generating unit 84 is sent to the displaying unit 62 via the display data outputting unit 86. The displaying unit 62 displays information depending on the posture of the shaped object 40 on the basis of the display data. The displaying unit 62 corresponds to a mode of a “display performing device”.

[Modification of System Configuration]

While in FIG. 1, the first information processing device 12 which functions as the controlling device of the 3D printer 14, and the second information processing device 18 which functions as the image processing device processing the image information of the head mounted display 16 are respectively constituted of separate computers, there can be a configuration in which the function of the first information processing device 12 and the function of the second information processing device 18 are realized by one computer.

Moreover, there can also be a mode in which a part of the function of the first information processing device 12 is implemented in the second information processing device 18, and a mode in which a part of the function of the second information processing device 18 is implemented in the first information processing device 12. Furthermore, the function of the first information processing device 12 and the function of the second information processing device may be realized by three or more plural computers sharing the functions.

Moreover, there can also be a mode in which a part of or the whole image processing function of the second information processing device 18 is implemented in the head mounted display 16. A head mounted wearable terminal which has the imaging function, the processing function of the captured image, and the generation function of the display data can be used as the head mounted display 16.

[Operation of Three-Dimensional Shaping System 10]

Next, a method of manufacturing the shaped object 40 by the three-dimensional shaping system 10 according to the embodiment, and a method of providing augmented reality using the manufactured shaped object 40 are described.

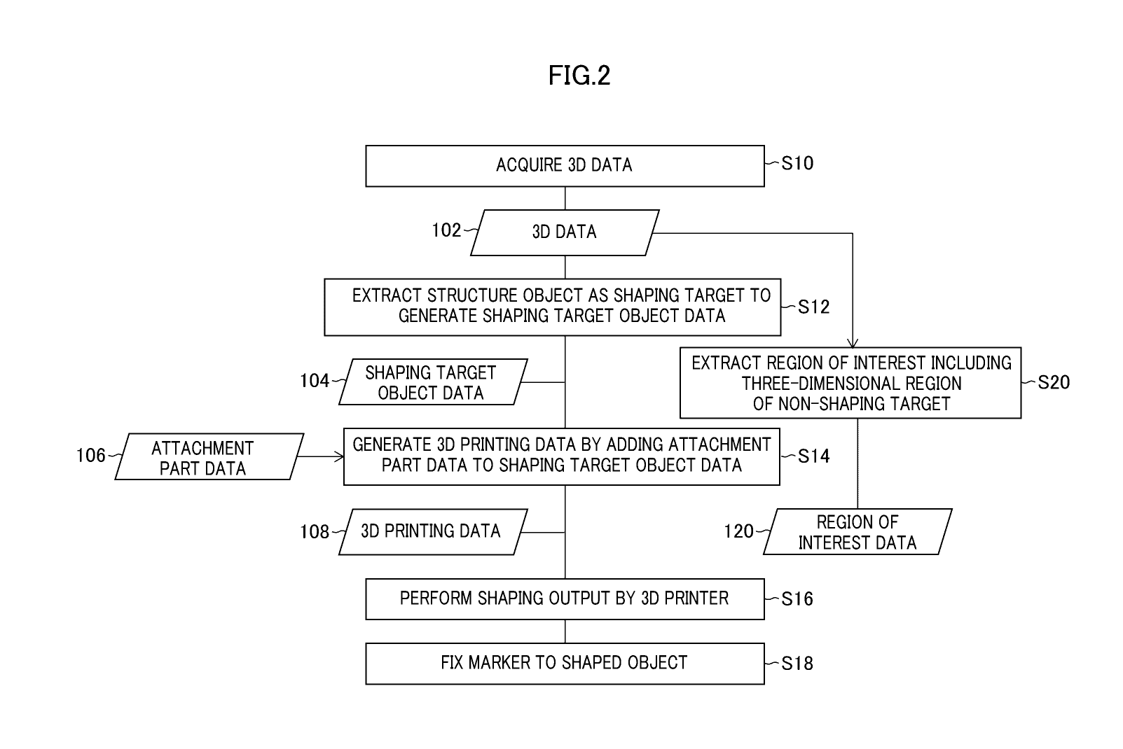

FIG. 2 is a flowchart showing a procedure of manufacturing the shaped object 40 by the three-dimensional shaping system 10. When the shaped object 40 is manufactured in accordance with the embodiment, first, original 3D data is acquired (step S10). A 3D data acquiring step in step S10 is performed by the first information processing device 12 described with FIG. 1. The first information processing device 12 acquires the 3D data via the 3D data acquiring unit 20. Step S10 corresponds to a mode of a “three-dimensional data acquiring step”.

Next, a structure object as a shaping target is extracted from 3D data 102 acquired in step S10 of FIG. 2 to generate shaping target object data (step S12). A shaping target object data generating step in step S12 is performed by the processing function of the shaping target object data generating unit 22 described with FIG. 1.

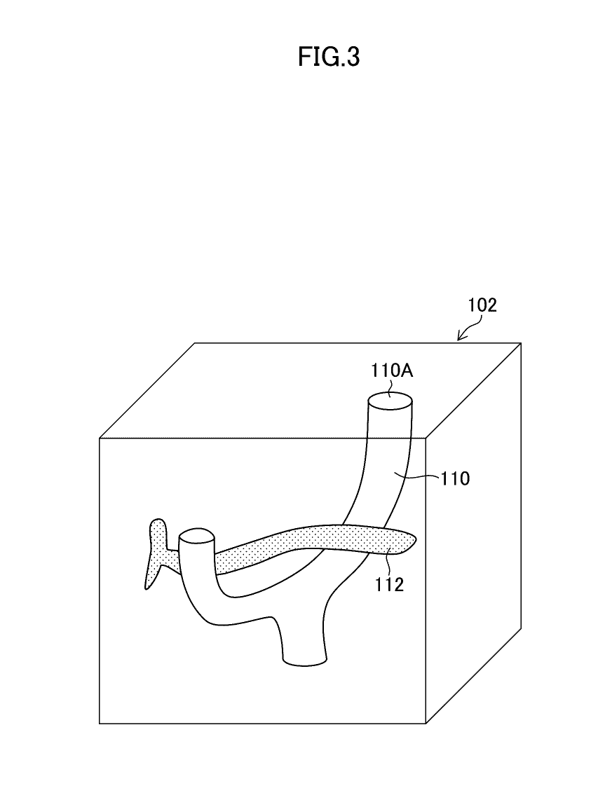

FIG. 3 is a schematic diagram of the 3D data acquired in step S10 of FIG. 2. FIG. 3 shows the 3D data 102 including a first structure object 110 and a second structure object 112 for the sake of simpleness of the description. Each of the first structure object 110 and the second structure object 112 is, for example, a blood vessel. Then, it is supposed that the structure object wanted to be printed (shaped and outputted) by the 3D printer 14 be the first structure object 110 out of the 3D data 102 shown in FIG. 3.

In this case, data corresponding to the first structure object 110 is extracted from the 3D data 102 in the shaping target object data generating step (step S12 of FIG. 2) to generate shaping target object data 104.

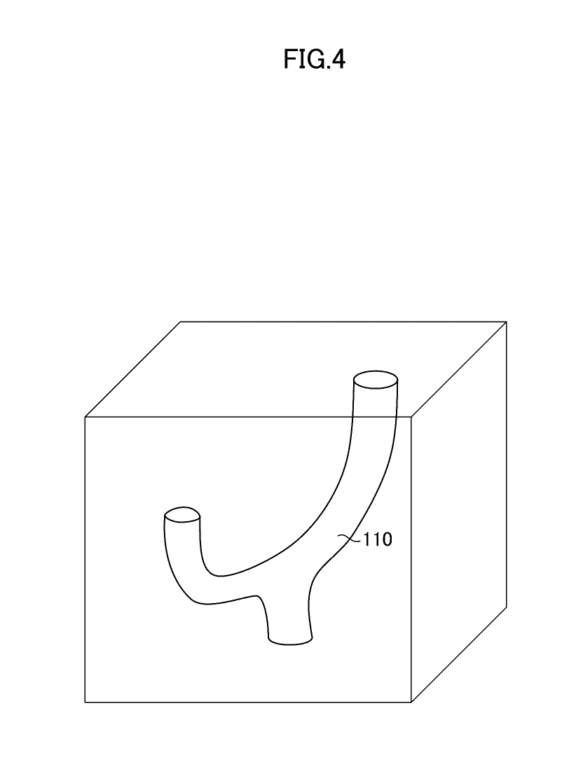

FIG. 4 is a schematic diagram showing a situation in which only the first structure object 110 which is the structure object as the shaping target is extracted from the 3D data 102 in FIG. 3. Three-dimensional data of the first structure object 110 shown in FIG. 4 corresponds to the shaping target object data 104 (refer to FIG. 2).

Next, 3D printing data is generated by adding attachment part data 106 to the shaping target object data 104 generated in step S12 of FIG. 2 (step S14). A 3D printing data generating step in step S14 is performed by the processing function of the 3D printing data generating unit 26 described with FIG. 1. The attachment part data 106 is data stored in the attachment data storing unit 24 described with FIG. 1. The 3D printing data generating step of step S14 corresponds to a mode of a “three-dimensional shaping data generating step”.

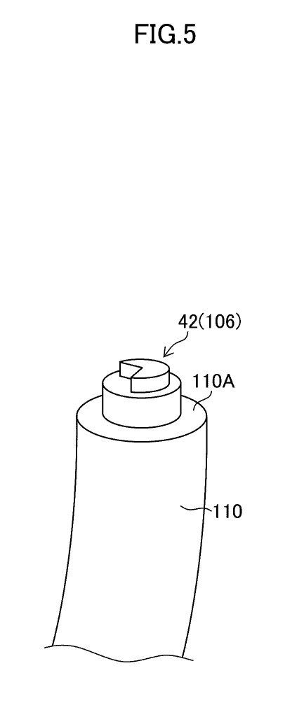

FIG. 5 is an expanded view of the main part showing a situation in which the attachment part data 106 is added on the data to the shaping target object data 104 described with FIG. 4. FIG. 5 shows an example in which the attachment part data 106 indicating a three-dimensional shape of the marker attachment part 42 is added (combined) to an end part 110A at the right top of the first structure object 110 shown in FIG. 4.

It is desirable that the marker 50 is attached to a specific place of the shaped object 40 at a singular position in a singular posture. Being “singular” is synonymous to being “unique”. The marker attachment part 42 exemplarily shown in FIG. 5 has a projection shape which is fitted to a recess part (hole) which is the connection part 52 of the marker 50, and has a three-dimensional shape which serves positioning and rotation regulation (rotation stopping) of the marker 50. The three-dimensional shape of the marker attachment part 42 is not limited to the example in FIG. 5 but can take various specific modes.

Next, shaping output is performed by the 3D printer 14 based on the 3D printing data 108 generated in step S14 of FIG. 2 (step S16). A three-dimensional shaping and outputting step of step S16 is performed by operating the 3D printer 14 described with FIG. 1.

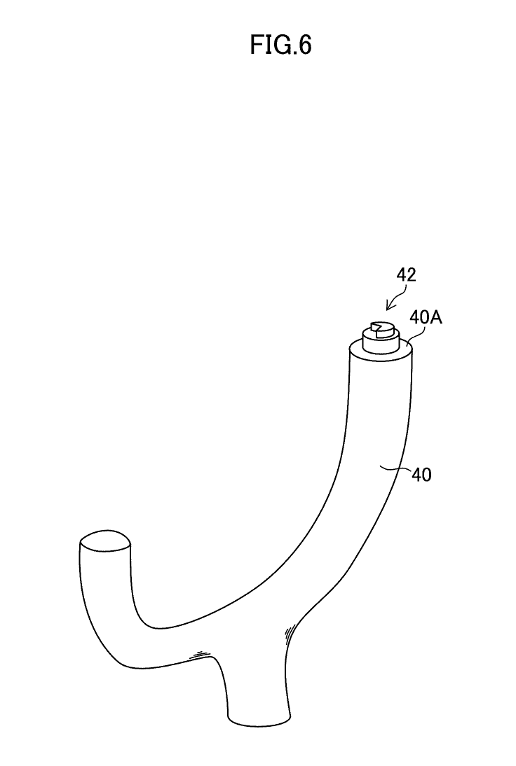

FIG. 6 is an example of the shaped object 40 shaped and outputted based on the 3D printing data 108 obtained by adding the attachment part data 106 of the marker attachment part 42 described with FIG. 5. This shaped object 40 is a three-dimensional shaped object in which the marker attachment part 42 is integrally formed at an end part 40A of the solid model of the first structure object 110.

After the shaped object 40 is manufactured in this way, the marker 50 is fixed to the shaped object 40 (step S18 of FIG. 2). A marker attaching step of step S18 is performed by fitting coupling between the marker attachment part 42 of the shaped object 40 and the connection part 52 of the marker 50. This process may be manually performed, or may also be automatically performed using a not-shown robot or the like.

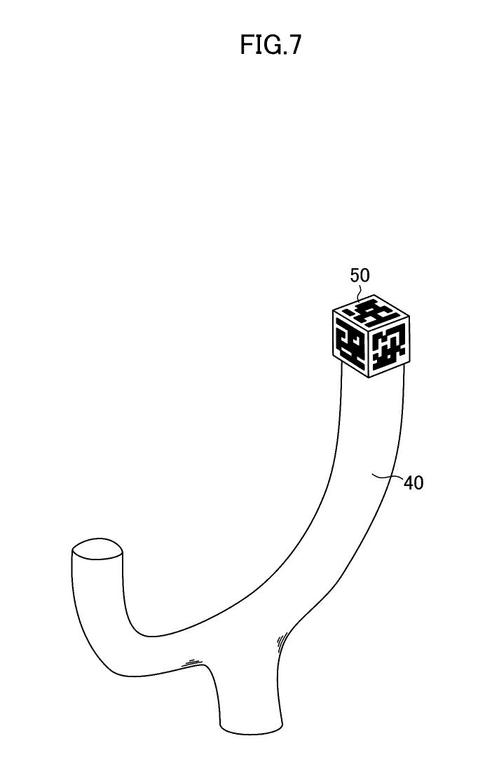

FIG. 7 is a diagram showing a situation in which the marker 50 is fixed to the shaped object 40 shown in FIG. 6. The shaped object 40 is imaged in the state where the marker 50 is attached to the shaped object 40 as in FIG. 7.

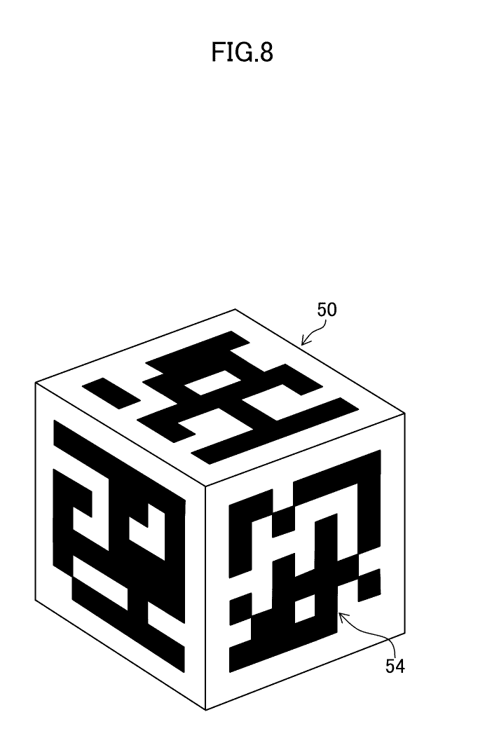

FIG. 8 is a perspective view exemplarily showing the marker 50. The marker 50 exemplarily shown in FIG. 8 has a hexahedral shape, and one face (bottom face in FIG. 8) of six faces of the hexahedron has a hole which is the connection part 52. In FIG. 8, the hole of the connection part 52 is not seen (refer to FIG. 1). The three-dimensional shape of the hole of the connection part 52 (not shown in FIG. 8) in the marker 50 is a shape with which the marker attachment part 42 of the shaped object 40 is singularly fitted thereto. To be “singularly fitted” means to be fitted at a unique position in a unique posture.

In the marker 50, the other five faces not relevant to the bottom face where the connection part 52 is formed are given geometric patterns 54 different from one another. Notably, the bottom face where the connection part 52 is formed may also be given a geometric pattern. Information regarding the geometric patterns 54 given the faces of the marker 50 and their positional relation on the marker 50, and information regarding the position of the connection part 52 and the shape of the hole are beforehand retained as the marker information in the marker information storing unit 78 (refer to FIG. 1). In the marker information, the position on the marker 50 is described in the marker coordinate system.

Next, a method of providing augmented reality using the shaped object 40 is exemplarily described.

Separate from the manufacturing process of the shaped object 40 described with step S10 to step S16 of FIG. 2, processing of extracting a region of interest including a three-dimensional region of a non-shaping target from the 3D data 102 acquired in step S10 is acquired (step S20). For example, the second structure object 112 shown in FIG. 3 can be set as the region of interest. A region of interest extracting step of step S20 is performed by the function of the region of interest extracting unit 72 described with FIG. 1. Region of interest data 120 extracted in the region of interest extracting step (step S20) is used for generating display data of the virtual object.

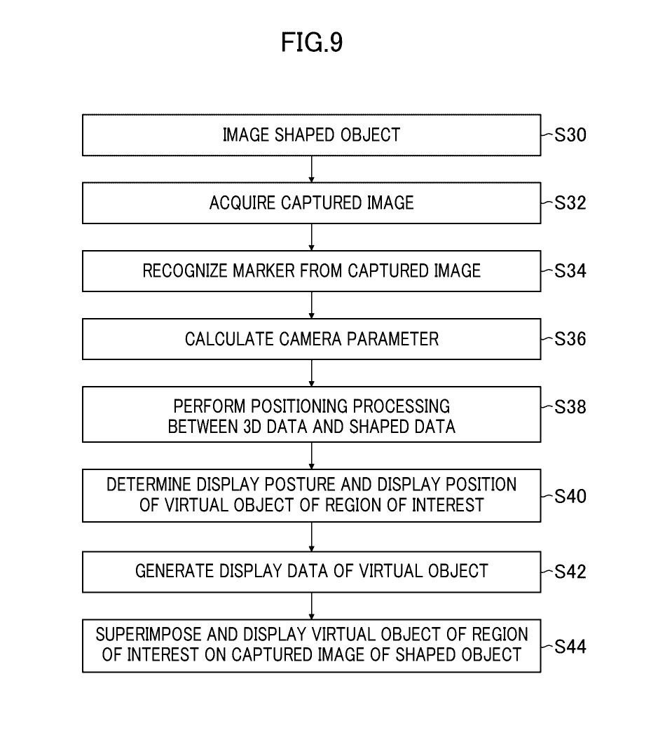

FIG. 9 is a flowchart exemplarily showing a method of providing augmented reality using the shaped object 40. The steps shown in the flowchart of FIG. 9 are performed by the head mounted display 16 and the second information processing device 18 in the three-dimensional shaping system 10 described with FIG. 1.

Upon the start of the flowchart of FIG. 9, first, the shaped object 40 is imaged by the imaging unit 60 of the head mounted display 16 (step S30) to acquire the captured image (step S32). Step S30 corresponds to a mode of an “imaging step”. A captured image acquiring step of step S32 corresponds to a step in which the second information processing device 18 takes in data of the captured image imaged by imaging unit 60.

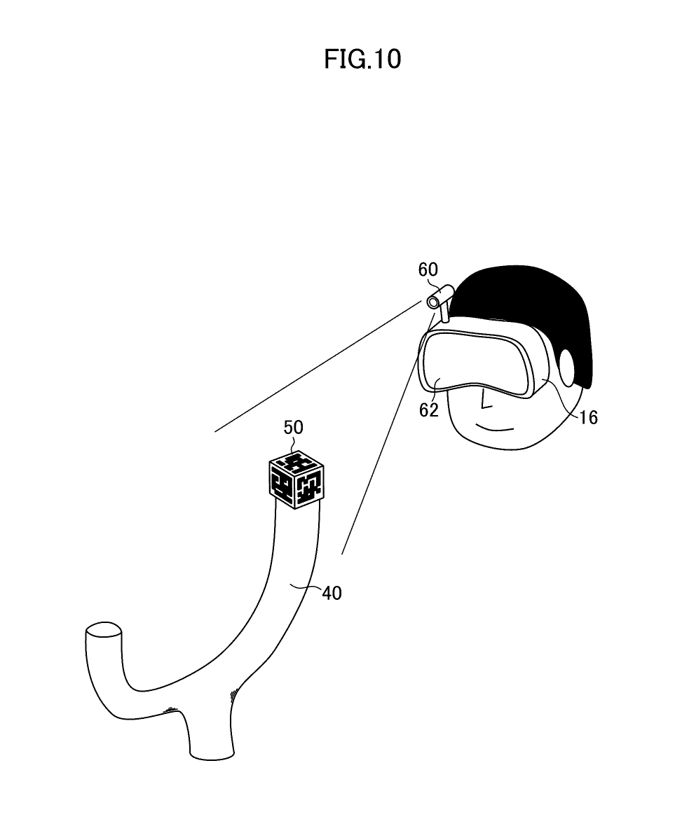

FIG. 10 is an explanatory drawing showing a situation in which the shaped object 40 is imaged. As shown in FIG. 10, the shaped object 40 is imaged by the imaging unit 60 in the state where the marker 50 is attached to the shaped object 40. The captured image of the shaped object 40 including the marker 50 is obtained by this imaging.

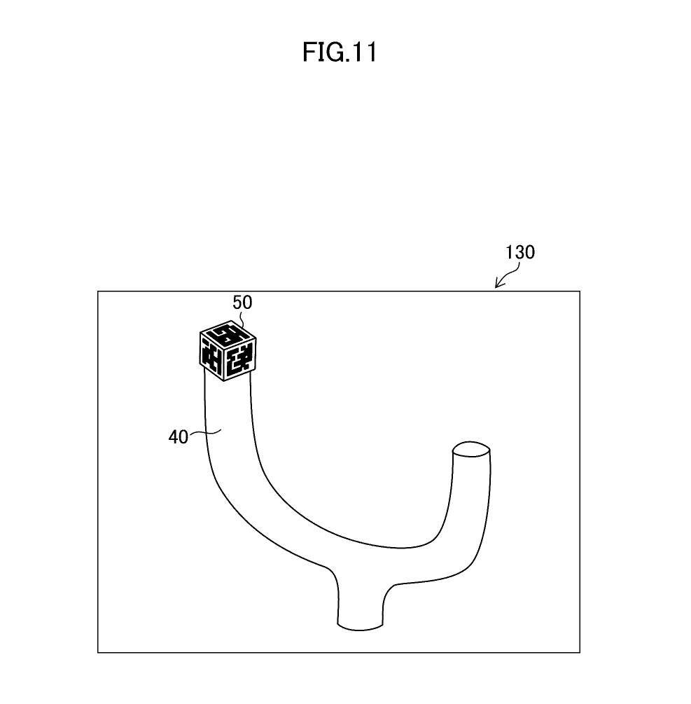

FIG. 11 shows an example of a captured image 130 imaged in the imaging situation of FIG. 10. The captured image 130 includes image information of the marker 50 and the shaped object 40.

After the captured image is acquired in step S32 of FIG. 9, processing of recognizing the marker 50 from the obtained captured image is performed (step S34), and the camera parameters are calculated based on the image information of the marker 50 (step S36). A marker recognizing step of step S34 and a camera parameter calculating step of step S36 are performed by the function of the camera parameter calculating unit 76 described with FIG. 1.

The camera parameter calculating unit 76 detects the position and the posture of the marker 50 based on the image information of the marker 50 grasped from the captured image and the beforehand retained marker information to calculate the camera parameters.

Since the attachment position and the attachment posture of the marker 50 with respect to the shaped object 40 are beforehand grasped, the information of the position and the posture of the shaped object 40 can be obtained from the camera parameters. Using the camera parameters, various kinds of information can be displayed on the displaying unit 62 depending on the position and the posture of the shaped object 40. While in this example, an example in which the virtual object of the region of interest is superimposed and displayed on the shaped object 40 is presented, information displayed on the displaying unit 62 is not limited to that in this example.

Succeedingly to step S36, the positioning processing between the 3D data and the shaped object 40 is performed (step S38). Since the shaped object 40 is shaped based on the 3D printing data generated from the 3D data, the positional relation between the coordinate system of the 3D data and that of the real shaped object 40 can be specified based on the information of the position and the posture of the shaped object 40 grasped from the camera parameters.

The display posture and the display position of the virtual object of the region of interest are determined based on the processing result of a positioning processing step of step S36 (step S40). A positioning processing step of step S38 and a virtual object display position determining step of step S40 are performed by the processing function of the positioning processing unit 80 described with FIG. 1.

Next, put forward to step S42 in FIG. 9, display data of the virtual object is generated. A display data generating step of step S42 is performed by the processing function of the display data generating unit 84 described with FIG. 1. Thus, the display data of the virtual object depending on the position and the posture of the shaped object 40 is generated and the display data is sent to the displaying unit 62.

The display data generated in step S42 is supplied to the displaying unit 62, and on the displaying unit 62, the virtual object of the region of interest is superimposed and displayed on the captured image of the shaped object 40 (step S44).

A displaying step of step S44 is performed by the processing function of the displaying unit 62 described with FIG. 1. Moreover, in superimposing and displaying the virtual object on the displaying unit 62, the image information of the shaped object 40 may be displayed with the image portion of the marker 50 erased from the captured image of the shaped object 40.

According to the embodiment, a virtual object of a region of interest which is the non-shaping target region can be superimposed and displayed on the shaped object 40 with which feeling of actual size can be grasped. In this way, positional relation between the shaped object 40 which is an actual three-dimensional model and the region of interest can be easily grasped, which enables preoperative simulation and a preoperative conference to be effectively performed.

Moreover, according to the embodiment, shaping output of a three-dimensional region (structure object) that is difficult to be shaped and outputted by a 3D printer can be omitted and replaced by display of a virtual object in augmented reality. Due to this, costs in time and material costs can be reduced.

The method described as the contents of the processing by the aforementioned first information processing device 12 can be understood as an information processing method for manufacturing a three-dimensional shaped object from 3D data.

Moreover, the method described as the contents of the processing by the first information processing device 12 and the second information processing device 18 can be understood as an information processing method useful for providing augmented reality using a shaped object shaped based on 3D data.

[Modification 1]

The attachment structure of the marker 50 with respect to the shaped object 40 is not limited to the configuration exemplarily shown in FIG. 5. There can also be a configuration in which one of the marker attachment part 42 of the shaped object 40 and the connection part 52 of the marker 50 is of male screw type and the other is of female screw type. Coupling by screwing is also included in the concept of “fitting coupling”.

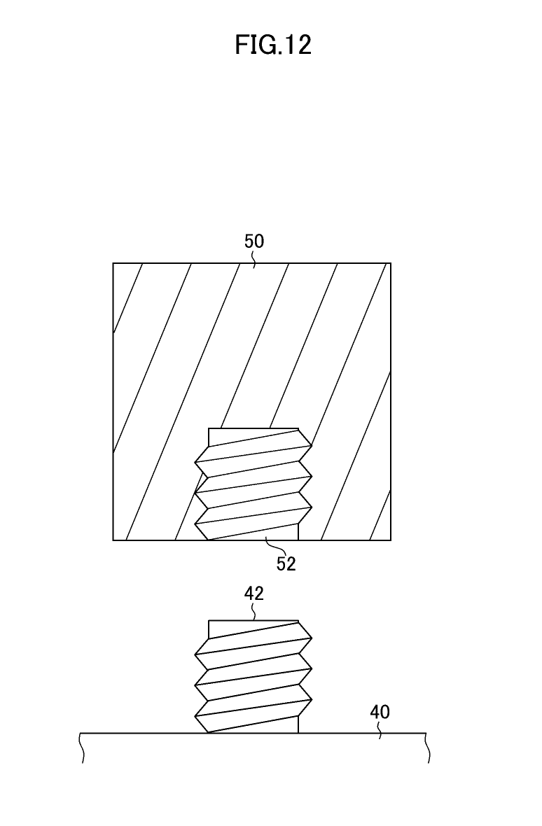

FIG. 12 is a cross-sectional view of the main part showing another embodiment regarding the attachment structure of the marker 50 with respect to the shaped object 40. FIG. 12 shows an example in which the marker attachment part 42 of the shaped object 40 is of male screw type and the connection part 52 of the marker 50 is of female screw type.

### Example

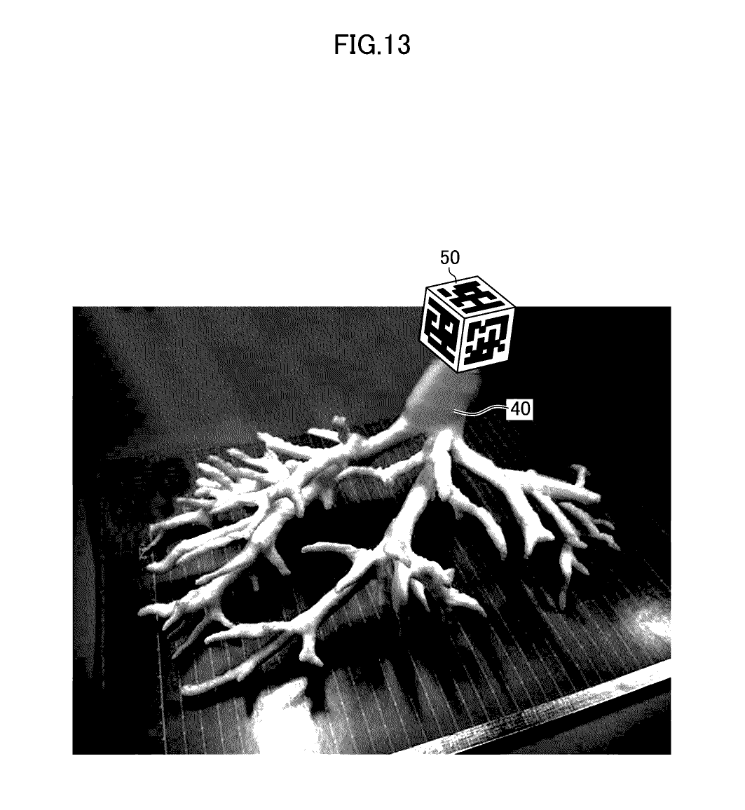

FIG. 13 is a perspective view showing a situation in which the marker 50 is fixed to the shaped object 40 obtained by shaping a model of blood vessels based on 3D data of the liver.

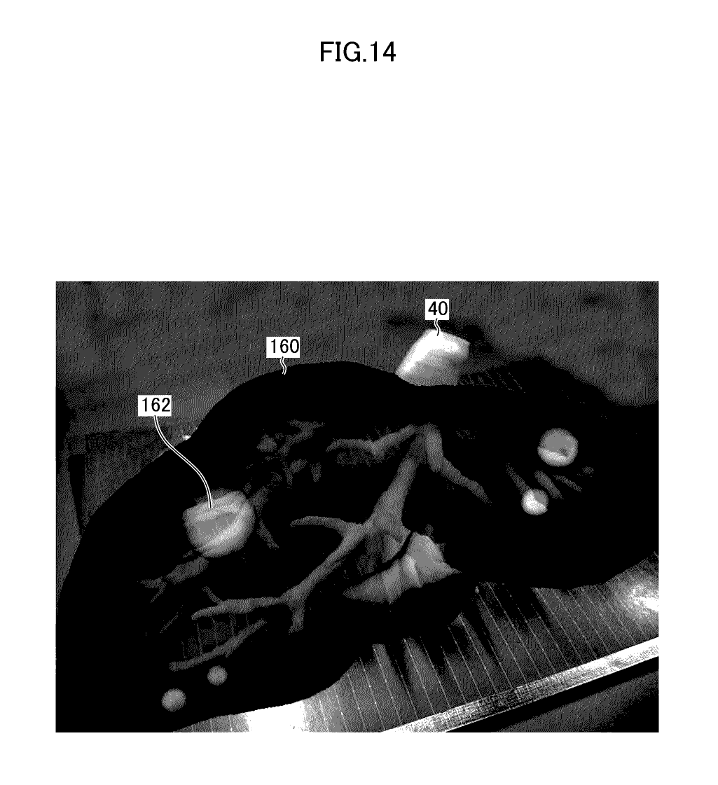

FIG. 14 is a diagram showing a display example in which the shaped object 40 shown in FIG. 13 is imaged and a virtual object 160 of the liver and a virtual object 162 of the lesion region are superimposed and displayed on the shaped object 40. In FIG. 14, the region enclosed by a circle is the virtual object 162 of the lesion region.

[Program for Causing Computer to Realize Processing Function of First Information Processing Device 12 and Processing Function of Second Information Processing Device 18]

A program for causing a computer to realize the processing function of the first information processing device 12 and the processing function of the second information processing device 18 described in the aforementioned embodiment can be recorded in a computer-readable medium (tangible and non-transitory information storage medium) such as a CD-ROM (Compact Disc Read-Only Memory) and a magnetic disc to provide the program via the information storage medium. In place of such a mode of storing and providing the program in an information storage medium, the program can also be provided as downloading service using a network such as the Internet.

Moreover, the processing function of the first information processing device 12 and/or the processing function of the second information processing device 18 described in the aforementioned embodiment can also be provided as an application server to perform service to provide the processing function via a network.

[Other Applications]

While in the aforementioned embodiment, an example in which 3D data obtained from the medical image diagnosis device 34 is handled is presented, the present invention can also be applied to a system which shapes and outputs a shaped object using three-dimensional CAD data.

Constituent elements can be properly modified, added and/or eliminated on the above-described embodiment of the present invention without departing from the spirit of the present invention. The present invention is not limited to the above-described embodiment but many alterations are possible within the scope of the technical idea of the present invention by persons with usual knowledge in the relevant field.

What is claimed is:

1. A three-dimensional shaping system comprising:
a three-dimensional data acquiring device which acquires three-dimensional data representing a three-dimensional structure object;
a shaping target object data generating device which generates shaping target object data representing a structure object as a shaping target from the three-dimensional data;
a three-dimensional shaping data generating device which generates three- dimensional shaping data by adding, to the shaping target object data, attachment part data representing a three-dimensional shape of a marker attachment part for attaching a positioning marker to a shaped object shaped based on the shaping target object data;
a three-dimensional shaping and outputting device which shapes and outputs the shaped object having the marker attachment part on the basis of the three-dimensional shaping data;
an imaging device which images the shaped object in a state where the marker is attached to the marker attachment part of the shaped object; and
a camera parameter calculating device which calculates a camera parameter including information representing relative positional relation between the imaging device and the shaped object by recognizing the marker from a captured image imaged by the imaging device.

2. The three-dimensional shaping system according to claim 1, wherein the camera parameter includes a position of the imaging device, an imaging direction of the imaging device, and a distance between the imaging device and the shaped object.

3. The three-dimensional shaping system according to claim 1, wherein the marker has a connection part connected to the marker attachment part, and the marker is fixed to the shaped object by fitting coupling between the connection part and the marker attachment part.

4. The three-dimensional shaping system according to claim 3, wherein one of the marker attachment part and the connection part is of male screw type and the other is of female screw type.

5. The three-dimensional shaping system according to claim 3, wherein the marker has a hole which is the connection part on one face of six faces of a hexahedron, and each of the other five faces is given a different pattern.

6. The three-dimensional shaping system according to claim 1, further comprising a positioning processing device which specifies a correspondence relation between the three-dimensional data and a position of the real shaped object based on the camera parameter.

7. The three-dimensional shaping system according to claim 1, further comprising:
a display data generating device which generates display data depending on a posture of the shaped object using the camera parameter; and
a display performing device which displays information depending on the posture of the shaped object on the basis of the display data.

8. The three-dimensional shaping system according to claim 7, further comprising:
a region of interest extracting device which extracts a region of interest at least including a three-dimensional region as a non-shaping target from the three-dimensional data, wherein
the display data generating device generates the display data for displaying a virtual object of the region of interest using the camera parameter based on three-dimensional data corresponding to the region of interest extracted by the region of interest extracting device.

9. The three-dimensional shaping system according to claim 8, wherein the display data generating device generates the display data for superimposing and displaying the virtual object on the captured image.

10. The three-dimensional shaping system according to claim 7, further comprising:
an image working device which erases and removes an image portion of the marker from the captured image, wherein
the display data generating device generates the display data for displaying an image in which the image portion of the marker is erased from the captured image.

11. The three-dimensional shaping system according to claim 1, wherein the three-dimensional data is medical image data acquired by a medical image diagnosis device.

12. An information processing method comprising:
a three-dimensional data acquiring step of acquiring three-dimensional data representing a three-dimensional structure object;
a shaping target object data generating step of generating shaping target object data representing a structure object as a shaping target from the three-dimensional data;
a three-dimensional shaping data generating step of generating three-dimensional shaping data by adding, to the shaping target object data, attachment part data representing a three-dimensional shape of a marker attachment part for attaching a positioning marker to a shaped object shaped based on the shaping target object data;
a three-dimensional shaping and outputting step of shaping and outputting the shaped object having the marker attachment part on the basis of the three-dimensional shaping data;
an imaging step of imaging by an imaging device the shaped object in a state where the marker is attached to the marker attachment part of the shaped object; and
a camera parameter calculating step of calculating a camera parameter including information representing relative positional relation between the imaging device and the shaped object by recognizing the marker from a captured image imaged by the imaging step.

13. An information processing device comprising:
a three-dimensional data acquiring device which acquires three-dimensional data representing a three-dimensional structure object;
a shaping target object data generating device which generates shaping target object data representing a structure object as a shaping target from the three-dimensional data;
an attachment data storing device which stores attachment part data representing a three-dimensional shape of a marker attachment part for attaching a positioning marker to a shaped object shaped based on the shaping target object data;
a three-dimensional shaping data generating device which generates three-dimensional shaping data by adding the attachment part data to the shaping target object data; and
a data outputting device which outputs the three-dimensional shaping data.

14. A three-dimensional shaping system comprising:
the information processing device according to claim 13; and
a three-dimensional shaping and outputting device which shapes and outputs the shaped object having the marker attachment part on the basis of the three-dimensional shaping data.

15. A non-transitory computer-readable tangible medium recording a program for causing a computer to function as the information processing device according to claim 13.
